(19) United States
(12) Patent Application Publication
(10) Pub. No.: US 2024/0032546 A1
(43) Pub. Date: Feb. 1, 2024

(54) BRASSICA SEED MEAL (BSM)-BASED BIO-HERBICIDE FOR INHIBITING WEED GERMINATION, AND PREPARATION METHOD AND USE THEREOF

(71) Applicant: Institute of Soil Science, CAS, Nanjing (CN)

(72) Inventors: Jiangang LI, Nanjing (CN); Junwei PENG, Nanjing (CN); Ziyu XIE, Nanjing (CN); Yuanhua DONG, Nanjing (CN)

(21) Appl. No.: 18/220,727

(22) Filed: Jul. 11, 2023

(30) Foreign Application Priority Data
Jul. 29, 2022 (CN) 202210905609.8

(51) Int. Cl. A01N 65/08; A01N 43/08

(52) U.S. Cl. CPC A01N 65/08; A01N 43/08

(57) ABSTRACT

The present disclosure provides a Brassica seed meal (BSM)-based bio-herbicide for inhibiting weed germination, and a preparation method and use thereof, and belongs to the technical field of bio-herbicides. In the present disclosure, the preparation method of a BSM-based bio-herbicide for inhibiting weed germination includes the following steps: adding vitamin C to a BSM, adjusting a water content and a pH value of the BSM, and conducting a sealing treatment on the BSM at 40° C. to 50° C. for 4 h to 6 h. The BSM-based bio-herbicide for inhibiting weed seed germination has a significant inhibitory effect on field weeds and can effectively control the growth of these weeds.

### CROSS REFERENCE TO RELATED APPLICATION

This patent application claims the benefit and priority of Chinese Patent Application No. 202210905609.8, filed with the China National Intellectual Property Administration on Jul. 29, 2022, the disclosure of which is incorporated by reference herein in its entirety as part of the present application.

### TECHNICAL FIELD

The present disclosure relates to the technical field of bio-herbicides, in particular to a Brassica seed meal (BSM)-based bio-herbicide for inhibiting weed germination, and a preparation method and use thereof.

### BACKGROUND

Setaria viridis L., Digitaria sanguinalis L., and Eleusine indica L. are common weeds in the field. The management of these weeds is a major challenge in agricultural production. There are many approaches to remove these weeds, including physical methods such as weeders and manual weeding, which are time-consuming and laborious. Alternatively, chemical herbicides such as quizalofop-p-ethyl, diquat, and glyphosate can also be adopted to control these weeds. The chemical herbicides have an ideal weeding effect. However, it is well known that chemical reagents have obvious disadvantages, such as the accumulation of toxic and harmful substances that cause unexpected damages to the soil. Moreover, these physical and chemical methods all take measures after weeds germinate and grow. If a method can be provided to inhibit the germination of weed seeds, the method may greatly improve a weeding efficiency, and save labors and weeding costs.

Brassica seed meal (BSM) is a by-product of the Brassica pre-pressing and leaching. With the increase of both biodiesel production and food oil demand in China, the “wastes” left after oil extraction, the BSM, also has a steadily increasing amount. These by-products are generally used as animal feed, but there are not many other applications of these by-products.

At present, there are few domestic studies on use of the BSM in inhibiting the growth of weeds. In recent years, there has been an upsurge of research on new bio-herbicides using plant materials abroad, and some achievements have been made. These plant materials release bioactive chemicals that provide resources for nutrient supplementation and weed suppression in crop growing systems. Brassica seed meal (BSM) in Cruciferae has abundant glucosinolates, which can generate isothiocyanates after hydrolysis. The isothiocyanates can inhibit the germination of weed seeds. In this way, the weed biomass during a crop growth period can be greatly reduced, thereby improving the yield and quality of the crops.

However, glucosinolates have different contents in different crops, as well as different growth stages and different physiological parts of the crops. For example, among cruciferous plants, the glucosinolates have a high content in the seeds of red cabbage and cress, and a highest content in the young shoots of radishes. Meanwhile, a method for generating the isothiocyanates from glucosinolates includes enzymatic processes and non-enzymatic processes, which are affected by conditions such as pressure and temperature. Moreover, the content of isothiocyanates is related to the effect of weed control. Therefore, it is a major problem to be solved to process the BSM to obtain a BSM-based bio-herbicide with a better herbicidal effect.

### SUMMARY

An objective of the present disclosure is to provide a Brassica seed meal (BSM)-based bio-herbicide for inhibiting weed germination, and a preparation method and use thereof. The present disclosure intends to obtain a bio-herbicide with a desirable weeding effect while realizing BSM utilization.

To achieve the above objective, the present disclosure provides the following technical solutions:

The present disclosure provides a preparation method of a BSM-based bio-herbicide for inhibiting weed germination, including the following steps: adding vitamin C to BSM, adjusting a water content and a pH value of the BSM, and conducting a sealing treatment on the BSM at 40° C. to 50° C. for 4 h to 6 h.

Preferably, the BSM is prepared by mixing a Brassica juncea L. seed meal (BjSM) and a Brassica campestris L. seed meal (BcSM) at a mass ratio of (1-2): (1-2).

Preferably, the vitamin C is added at 0.1% to 0.5% of a mass of the BSM.

Preferably, the water content after adjustment is 10% to 25%.

Preferably, the pH value after adjustment is 5 to 7.

The present disclosure further provides a BSM-based bio-herbicide for inhibiting weed germination prepared by the preparation method.

The present disclosure further provides use of the BSM-based bio-herbicide in inhibiting weed germination.

Preferably, the weed includes one or more of Portulaca oleracea L., Bothriochloa ischaemum L., Eleusine indica L., Setaria viridis L., and Amaranthus spinosus L.

The present disclosure provides a BSM-based bio-herbicide for inhibiting weed germination, where the bio-herbicide is prepared by mixing a BjSM and a BcSM. The bio-herbicide has a remarkable inhibitory effect on the seed germination of field weeds and can effectively control the growth of these weeds. Compared with traditional physical weeding methods, such as manual weeding and weeders, the bio-herbicide saves time and effort. Compared with aggressive chemical herbicides, such as quizalofop-p-ethyl, diquat, and glyphosate, the bio-herbicide shows environmental protection and sustainability, and does not cause damages to the soil environment.

### BRIEF DESCRIPTION OF THE DRAWINGS

FIG. 1 shows germination inhibition rates of different treatments in Experiment 1 to Setaria viridis L.;

FIG. 2 shows germination inhibition rates of different BSM treatments in Experiment 2 to Setaria viridis L.;

FIG. 3 shows germination inhibition rates of different treatments in Experiment 3 to field weed seeds.

### DETAILED DESCRIPTION OF THE EMBODIMENTS

The present disclosure provides a preparation method of a BSM-based bio-herbicide for inhibiting weed germination, including the following steps: adding vitamin C to BSM, adjusting a water content and a pH value of the BSM, and conducting a sealing treatment on the BSM at 40° C. to 50° C. for 4 h to 6 h.

In the present disclosure, the BSM is prepared by mixing a BjSM and a BcSM at a mass ratio of preferably (1-2):(1-2), more preferably 1:1.

In the present disclosure, the vitamin C is added at preferably 0.1% to 0.5%, more preferably 0.2% to 0.4%, and even more preferably 0.3% of a mass of the BSM.

In the present disclosure, the water content after adjustment is preferably 10% to 25%, more preferably 15% to 20%, and even more preferably 18%.

In the present disclosure, the pH value after adjustment is preferably 5 to 7, more preferably 6.

In the present disclosure, the sealing treatment is conducted at more preferably 45° C. for more preferably 5 h.

The present disclosure further provides a BSM-based bio-herbicide for inhibiting weed germination prepared by the preparation method.

The present disclosure further provides use of the BSM-based bio-herbicide in inhibiting weed germination.

In the present disclosure, the weed includes preferably one or more of Portulaca oleracea L., Bothriochloa ischaemum L., Eleusine indica L., Setaria viridis L., and Amaranthus spinosus L., more preferably the Portulaca oleracea L., the Bothriochloa ischaemum L., the Eleusine indica L., the Setaria viridis L., and the Amaranthus spinosus L.

The technical solutions provided by the present disclosure will be described in detail below with reference to examples, but the examples should not be construed as limiting the claimed scope of the present disclosure.

### EXAMPLE 1

A BjSM and a BcSM were uniformly mixed at a mass ratio of 1:1 to obtain mixed BSM. Vitamin C was added at 0.3% of a mass of the mixed BSM, and a resulting mixture was adjusted to a water content of 18% and a pH value of 6. A sealing treatment was conducted at 45° C. for 5 h to obtain a BSM-based bio-herbicide.

### EXAMPLE 2

A BjSM and a BcSM were uniformly mixed at a mass ratio of 1:1.5 to obtain mixed BSM. Vitamin C was added at 0.5% of a mass of the mixed BSM, and a resulting mixture was adjusted to a water content of 25% and a pH value of 5. A sealing treatment was conducted at 40° C. for 6 h to obtain a BSM-based bio-herbicide.

### EXAMPLE 3

A BjSM and a BcSM were uniformly mixed at a mass ratio of 1.5:1 to obtain mixed BSM. Vitamin C was added at 0.1% of a mass of the mixed BSM, and a resulting mixture was adjusted to a water content of 15% and a pH value of 7. A sealing treatment was conducted at 50° C. for 4 h to obtain a BSM-based bio-herbicide.

### Experimental Example 1

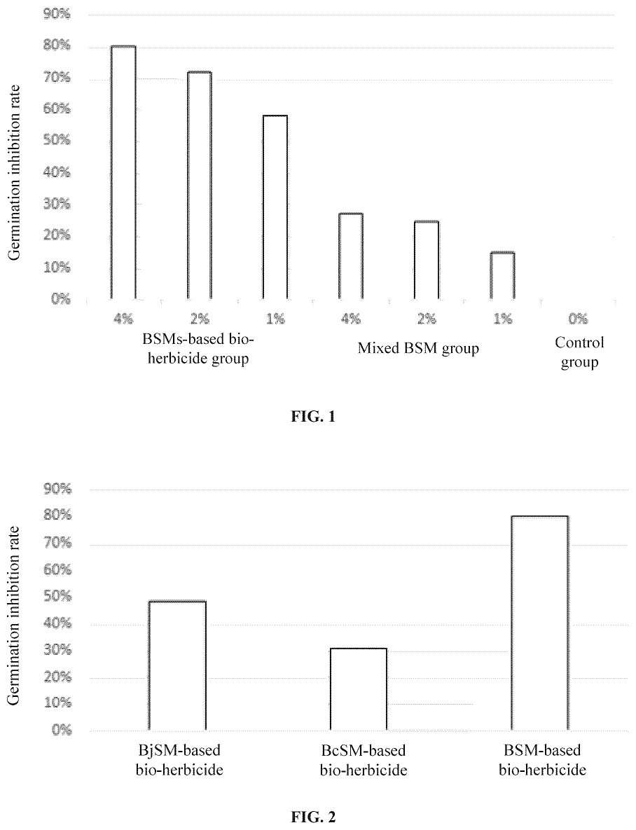

150 g of soil was separately mixed with 6 g (4% w/w), 3 g (2% w/w), and 1.5 g (1% w/w) of the BSM-based bio-herbicide prepared in Example 1 (prepared for immediate use) evenly, and then water was added at 40% of a soil mass to make the soil reach a certain humidity. An obtained mixture was placed in a pot, and 150 Setaria viridis seeds were evenly sown into the soil, and then cultivated at 25° C. for 7 d under plastic wrap sealing. Meanwhile, untreated mixed BSM prepared by a BjSM and a BcSM mixed at a mass ratio of 1:1 were taken as a comparative example, and addition groups of 6 g, 3 g, and 1.5 g were set up. A control was set up without adding the BSM. On an 8th day, the plastic wrap was removed, and the germination of the Setaria viridis seeds was counted. The results were shown in Table 1, and a calculated germination inhibition rate was shown in FIG. 1.

TABLE 1
Germination of Setaria viridis under different treatments

| | | Sowing | Germinated | | Germination |
|---|---|---|---|---|---|
| | | amount/ | number/ | Germination | inhibition |
| Treatment | | seeds | seeds | rate | rate |
| BSM-based | 4% | 150 | 30 | 20% | 80% |
| bio-herbicide | 2% | 150 | 42 | 28% | 72% |
| | 1% | 150 | 63 | 42% | 58% |
| Mixed BSM | 4% | 150 | 109 | 73% | 27% |
| | 2% | 150 | 113 | 75.3% | 24.7% |
| | 1% | 150 | 128 | 85.3% | 14.7% |
| Control | 0 | 150 | 150 | 100% | 0 |

It was seen intuitively from FIG. 1 that after treatment, the germination inhibition rate of a mixed BSM on Setaria viridis was significantly improved. When an addition amount of the mixed BSM was 4%, the germination inhibition rate of Setaria viridis could reach 80%.

### Experimental Example 2

A BjSM and a BcSM were treated separately according to the method of Example 1 to obtain a BjSM-based bio-herbicide and a BcSM-based bio-herbicide. According to the method of Experimental Example 1, the weed germination inhibition rate experiment with an addition amount of 4% was conducted, and the statistical results were compared with those of the 4% addition amount group in Example 1. The results were shown in Table 2 and FIG. 2.

TABLE 2
Germination of Setaria viridis under different BSM treatments

| | Sowing | Germinated | | Germination |
|---|---|---|---|---|
| | amount/ | number/ | Germination | inhibition |
| Treatment | seeds | seeds | rate | rate |
| BjSM-based | 150 | 78 | 52% | 48% |
| bio-herbicide | | | | |
| BcSM-based | 150 | 104 | 69.3% | 30.7% |
| bio-herbicide | | | | |
| BSM-based | 150 | 30 | 20% | 80% |
| bio-herbicide | | | | |

As shown in Table 2 and FIG. 2, the weed germination inhibition rate of mixed BSM was significantly higher than that of the single type of BSM.

### Experimental Example 3

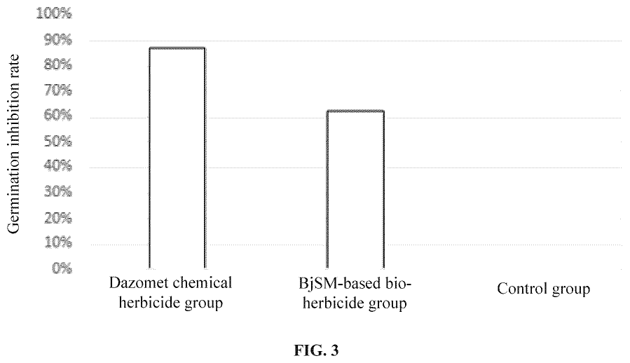

Dazomet was added to the field soil at 40 g/m 2 of soil (as a treatment 1). The BSM-based bio-herbicide (Example 1) was added to another field soil at 0.8 wt % of the BSM per mu of soil (1 mu=300,000 jin) (as a treatment 2). The same area of field soil without adding any exogenous substances was used as a control. After 1 week, the weed growth of the two treatments and the control (field weeds included Portulaca oleracea L., Bothriochloa ischaemum L., Eleusine indica L., Setaria viridis L., and Amaranthus spinosus L.) was counted, and the germination inhibition rate of weed seeds was calculated. The results were shown in FIG. 3.

The weight of field weeds was 0.204 kg/m² for the treatment with dazomet, 0.588 kg/m² for the treatment with BSM-based bio-herbicide, and 1.550 kg/m² for the control. As shown in FIG. 3, compared with the control, the inhibition rates of the dazomet and the BSM-based bio-herbicide to the field weeds were as high as 86.84% and 62.06%, respectively.

As can be seen from the above examples, the present disclosure provides a BSM-based bio-herbicide for inhibiting weed germination, where the bio-herbicide is prepared by mixing a BjSM and a BcSM. The bio-herbicide has a remarkable inhibitory effect on the field weeds and can effectively control the growth of these weeds. Compared with traditional physical weeding methods, such as manual weeding and weeders, the bio-herbicide saves time and effort. Compared with aggressive chemical herbicides, such as quizalofop-p-ethyl, diquat, and glyphosate, the bio-herbicide shows environmental protection and sustainability, and does not cause damages to the soil environment.

The above are merely preferred implementations of the present disclosure. It should be noted that several improvements and modifications may further be made by a person of ordinary skill in the art without departing from the principle of the present disclosure, and such improvements and modifications should also be deemed as falling within the protection scope of the present disclosure.

What is claimed is:

1. A preparation method of a Brassica seed meal (BSM)-based bio-herbicide for inhibiting weed germination, comprising the following steps: adding vitamin C to a BSM, adjusting a water content and a pH value of the BSM, and conducting a sealing treatment on the BSM at 40° C. to 50° C. for 4 h to 6 h.

2. The preparation method according to claim 1, wherein the BSM is prepared by mixing a Brassica juncea L. seed meal (BjSM) and a Brassica campestris L. seed meal (BcSM) at a mass ratio of (1-2):(1-2).

3. The preparation method according to claim 2, wherein the vitamin C is added at 0.1% to 0.5% of a mass of the BSM.

4. The preparation method according to claim 3, wherein the water content of the BSM after adjustment is 10% to 25%.

5. The preparation method according to claim 1, wherein the pH value of the BSM after adjustment is 5 to 7.

6. The preparation method according to claim 2, wherein the pH value of the BSM after adjustment is 5 to 7.

7. The preparation method according to claim 3, wherein the pH value of the BSM after adjustment is 5 to 7.

8. The preparation method according to claim 4, wherein the pH value of the BSM after adjustment is 5 to 7.

9. A BSM-based bio-herbicide for inhibiting weed germination prepared by the preparation method according to claim 1.

10. The BSM-based bio-herbicide according to claim 9, wherein the BSM is prepared by mixing a Brassica juncea L. seed meal (BjSM) and a Brassica campestris L. seed meal (BcSM) at a mass ratio of (1-2):(1-2).

11. The BSM-based bio-herbicide according to claim 10, wherein the vitamin C is added at 0.1% to 0.5% of a mass of the BSM.

12. The BSM-based bio-herbicide according to claim 11, wherein the water content of the BSM after adjustment is 10% to 25%.

13. The BSM-based bio-herbicide according to claim 9, wherein the pH value of the BSM after adjustment is 5 to 7.

14. The BSM-based bio-herbicide according to claim 9, wherein the BSM-based bio-herbicide is capable of inhibiting weed germination.

15. The BSM-based bio-herbicide according to claim 10, wherein the BSM-based bio-herbicide is capable of inhibiting weed germination.

16. The BSM-based bio-herbicide according to claim 11, wherein the BSM-based bio-herbicide is capable of inhibiting weed germination.

17. The BSM-based bio-herbicide according to claim 12, wherein the BSM-based bio-herbicide is capable of inhibiting weed germination.

18. The BSM-based bio-herbicide according to claim 13, wherein the BSM-based bio-herbicide is capable of inhibiting weed germination.

19. The BSM-based bio-herbicide according to claim 14, wherein the weed comprises one or more of Portulaca oleracea L., Bothriochloa ischaemum L., Eleusine indica L., Setaria viridis L., and Amaranthus spinosus L.

20. The BSM-based bio-herbicide according to claim 15, wherein the weed comprises one or more of Portulaca oleracea L., Bothriochloa ischaemum L., Eleusine indica L., Setaria viridis L., and Amaranthus spinosus L.
